(19) United States
(12) Patent Application Publication
(10) Pub. No.: US 2025/0371012 A1
(43) Pub. Date: Dec. 4, 2025

(54) ACCESSING DATA VIA A TRANSFORMER MODULE THAT ADDS SECURITY-SPECIFIC ANNOTATIONS TO A QUERY

(71) Applicant: Università della Svizzera italiana (USI), Lugano (CH)

(72) Inventors: Shamiek Mangipudi, Lugano (CH); Pavel Chuprikov, Lugano (CH); Patrick Eugster, Lugano (CH)

(21) Appl. No.: 18/680,507

(22) Filed: May 31, 2024

(51) Int. Cl. G06F 16/2453; G06F 21/60

(52) U.S. Cl. CPC G06F 16/24547; G06F 21/602

(57) ABSTRACT

In a computer system with multiple physical computers at different physical locations, a transformer module receives an original query from a client-side computer, analyzes the query statements and annotates the query. The transformer module forwards the annotated query to server-computers. This approach allows a data-analyst 190-ALPHA to use a query that is relatively simple, wherein a data-analyst 190-BETA who does not benefit from the transformer module would have to write a more complex query.

### TECHNICAL FIELD

The disclosure generally relates to exchanging data between computers at different

physical locations, and more in particular relates to the communication between client-side and server-side computers to retrieve and process security-critical data.

### BACKGROUND

From an overall perspective, computers process information that is available in form of data. Data-security goals need to be considered, such as for example (i) the goal to preserve confidentiality of information, (ii) the goal to authenticate users that access information, (iii) the goal to keep the integrity of information unchanged, and others.

Some of these goals are relevant during transit (i.e., when data is being transmitted between computers), storage (i.e., when data is being stored for subsequent retrieval), and computation (i.e., during or after retrieval). Encrypting from plain data to cipher data (and subsequently decrypting, from cipher data back to plain data) is a wide-spread technical measure to preserve confidentiality. Encrypting and decrypting play a role for the other goals as well.

There is a general trend to perform different data-related activities by separate physical computers at different physical locations. Therefore, data needs to be accessed across networks that link the computers. This trend has many motivations, such as to increase efficiency in data processing.

Data-analysts decide what data to retrieve and to process, and the data-analysts formulate queries.

However, for the confidentiality goal alone, the complexity to use different encrypting mechanisms conflicts with data processing efficiency. Encrypting all data according to the highest possible standard would lose the advantages of separation, and not encrypting at all would put security at risk. The skilled person takes an approach between both extremes and selects between different encryption mechanisms.

For some applications, the skilled person may even take an encryption mechanism that supports computation on encrypted data.

However, differentiating the encryption mechanisms adds complexity, and the data-analysts have to take different encryption mechanisms into account as well. That additional burden is error-prone and reduces the mentioned efficiency.

### SUMMARY

A transformer module performs a computer-implemented method for accessing data being stored on server-computers in a data-center. The transformer module receives an original query from a client-side computer. The original query identifies the data to be accessed by at least first and second data statements as well as at least one operation statement. The transformer module analyzes the first and second data statements of the received original query and identifies a corresponding encryption mechanism for the data to be accessed, and also identifies the corresponding processing mechanism.

The transformer module forwards the query as annotated query to a server-computer in the data-center.

As the encryption mechanism is derivable from a security policy, the annotated query comprises the information that allows the data-center to read-access the data. The annotations have the function to code the encryption modality, and some of the annotations can have the form of meta-data.

Despite complexity in the encryption mechanism, the data-analysts do not have to take different encryption mechanisms into account any longer. Using annotations added by the transformer module automatically is expected to be less error-prone, and the overall data processing efficiency is expected to rise.

The annotations alone do not allow attackers to compromise security. The transformer module provides the annotations as an extension to the query language.

At the data-center, the annotations are evaluated while accessing the data. The annotations can also be used to decrypt the result.

The annotations are provided in correspondence with a so-called lattice that implements the security policy. The lattice not only indicates security levels, but also indicates a mapping to domains and schemes.

In that sense, the transformer module acts as an abstraction layer.

A computer-implemented method is a method for processing data being stored on server-computers in a data-center. A transformer module is receiving an original query from a client-side computer. The original query comprises query statements that are at least first and second data statements that identify the data to be accessed, and at least one operation statement that identifies an operation to be performed with the data. The transformer module is analyzing the query statements of the original query to identify a corresponding encryption mechanism and to identify a corresponding processing mechanism. The transformer module operates according to a pre-defined security policy. The transformer module is annotating the original query by pre-defined annotations that identify both the corresponding encryption mechanisms and the corresponding processing mechanism. The transformer module is forwarding the annotated query to a server-computer.

Optionally, an executor module that is associated with the server-computer is receiving and processing the annotated query. According to the annotations, the executor module processes the statements at different storage locations in the data-center and activates the corresponding encryption schemes.

Optionally, the corresponding encryption mechanism and the corresponding processing mechanism use partially homomorphic encryption so that the executor module accesses and processes the data in encrypted form.

Optionally, the statements are defined by symbols in a first programming language. The transformer module provides the annotations in a second programming language that is an extension to the first programming language.

Optionally, the step annotating the original query comprises to annotate the query with runtime-only constructs that the data-center does not persist.

Optionally, the step analyzing the first and second data statements is based on a policy that uses a lattice structure with a finite and pre-defined number of ordered confidentiality levels so that the transformer module identifies encryption mechanisms that are level-compatible.

Optionally, the corresponding encryption mechanisms are specific to encryptions schemes and to domains.

Optionally, in step analyzing, the transformer module identifies the corresponding processing mechanism also according to the policy with the lattice structure.

Optionally, the step annotating the received original query is followed by compiling the annotated query by a compiler-optimizer module so that forwarding is performed with a compiled query.

Optionally, the step analyzing the first and second data statements and the operation statement of the received original query comprises to identify an encryption scheme by that the data from the first and second data statements is being processed by homomorphic encryption. In other words, data processing is based on data with homomorphic encryption and the scheme is identified accordingly.

A computer program product is tangibly embodied on a non-transitory computer-readable storage medium and comprises instructions that, when executed by at least one computing device, are configured to cause the at least one computing device to execute the steps of the computer-implemented method.

A system comprises at least one memory including instructions and at least one processor (that is operably coupled to the at least one memory and that is arranged and configured to execute instructions). The instructions-when executed-cause the at least one processor to perform the method steps.

### BRIEF DESCRIPTION OF THE DRAWINGS

FIG. 1 illustrates a diagram of a computer system with physical computers at different physical locations;

FIG. 2 illustrates the system of FIG. 1 at least partially, but with optimal components and with intermediate results to illustrate a workflow;

FIG. 3 illustrates a part of the system of FIG. 1, that is a client-computer and a transformer module;

FIGS. 4A and 4B illustrate aspects of the programming languages, for an original query that is not yet annotated and for an annotated query;

FIG. 5 illustrates an example of an original query on top of the page and illustrates an annotated query below;

FIG. 6 illustrates a flow-chart of a computer-implemented method for processing data that are stored in a data-center with server-computers; and

FIG. 7 illustrates a generic computer and a mobile device.

### DETAILED DESCRIPTION

### Introduction

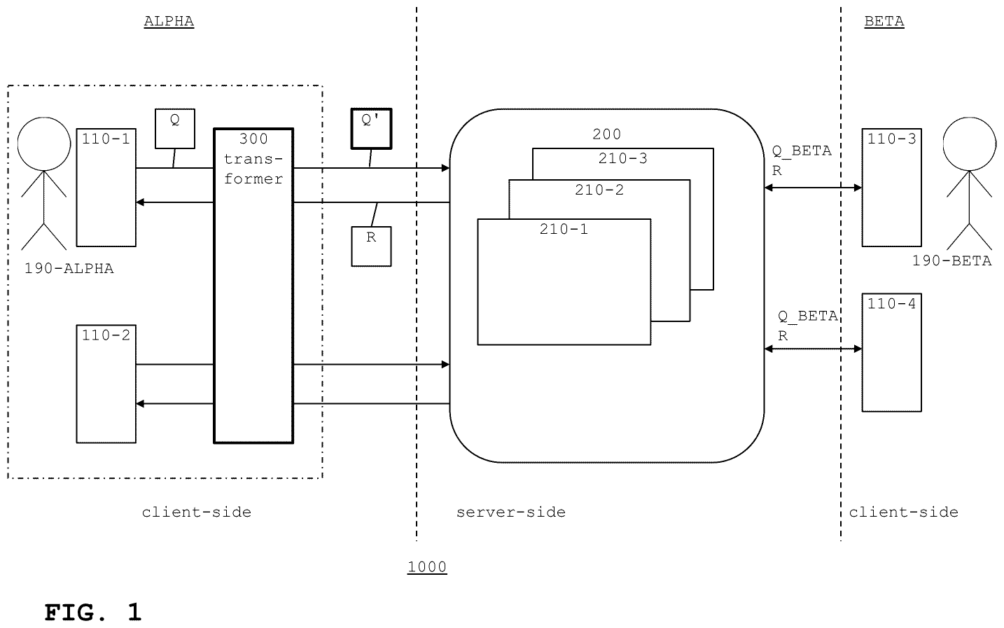

FIG. 1 illustrates a diagram of computer system 1000 with multiple physical computers at different physical locations. In a simplified example, data-center 200 (occasionally, the “cloud”) comprises multiple cloud computers 210-1, 210-2, 210-3 (collectively cloud computer(s) 210) that can be specialized in storing and processing data. Multiple peripheral computers 110-1, 110-2, 110-3, 110-4 (collectively computer(s) 110, or “edge computer(s)”) can be specialized in interacting with human users. The description uses the metaphorical terms “cloud” and “edge” only to indicate that different computers may have different functions.

Different terminology is applicable, such as client-side computers 110 and server-side computers 210. The skilled person is familiar with certain activity sequences. For example, and simplified, edge computer 110 sends a query Q to data-center 200 to access data (e.g., to read data) in one of the cloud computers 210, and cloud computer 210 returns a response R (or “result”) with the data, and so on. The data can be distributed across different cloud computers 210.

From the view point of an individual edge computer, the cloud computers would not be visible individually, but the skilled person can channel the data accordingly. For example, the query Q from computer 110-1 would be routed to one or more of computers 210-1, 210-2, or 210-3 automatically.

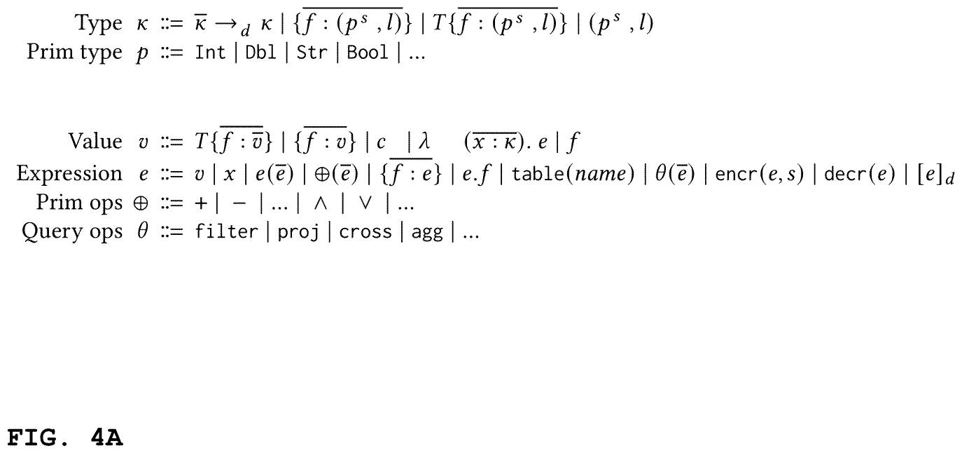

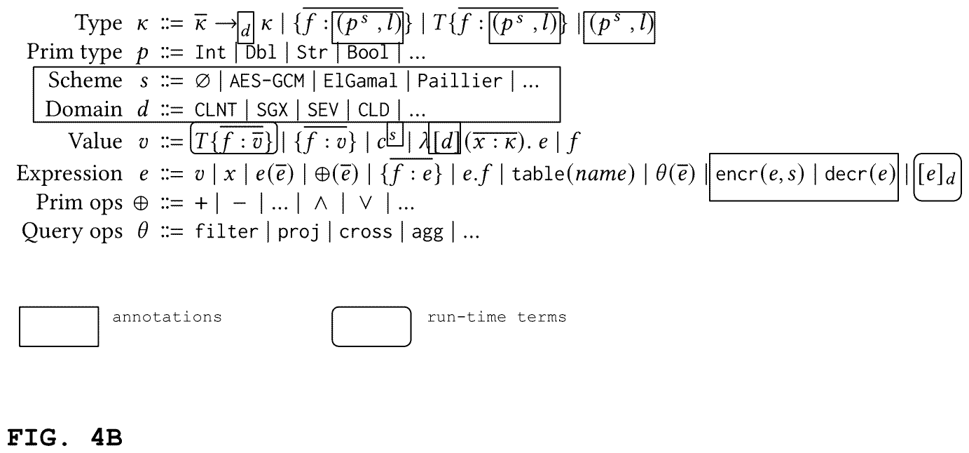

The skilled person is familiar with such queries Q, and query tools are commercially available. By way of example, data access within data-center 200 can be arranged with an analytics engine SPARK available from the Apache Software Foundation (“Apache Spark analytics engine”). The query Q would have to be provided in a programming language that is understood by such tools (cf. FIGS. 4A and 4B for their syntax, by way of example). The analytics engine can access data that are stored by the cloud computers in databases. The description therefore takes the interaction with databases as an illustrative example, but other storage approaches are applicable as well.

In the following, the query Q is symbolized by query statements. The query Q has a plurality of data statements (e.g., “get A” and get B” to identify certain variables) and has at least one operation statement that represents an operation (or computation, such as a function f(A,B)) that has to be performed with the identified data.

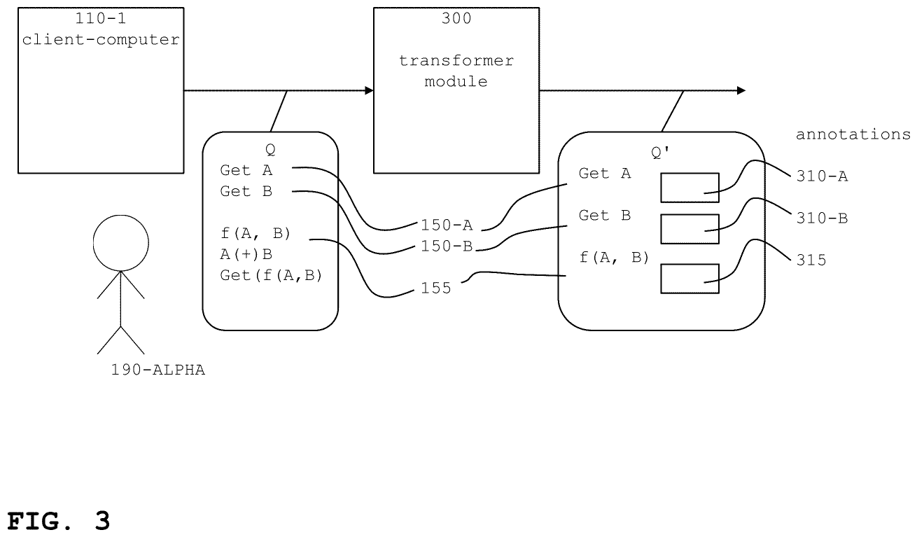

For example, a first data statement “get A” and a second data statement “get B” (cf. FIG. 3) would cause a computer (such as a computer in data-center 200) to retrieve the values of variables A and B from storage (in data-center 200), and an operation statement would cause the computer to calculate the function f(A, B) according to the operation statement.

For example, the query Q should identify the variables A and B and should identify the function f(A,B) as the addition A+B (alternatively, as multiplication A*B, etc.). Statements can be combined. For example, “Get (f(A,B)” in FIG. 3 combines data and operation statements.

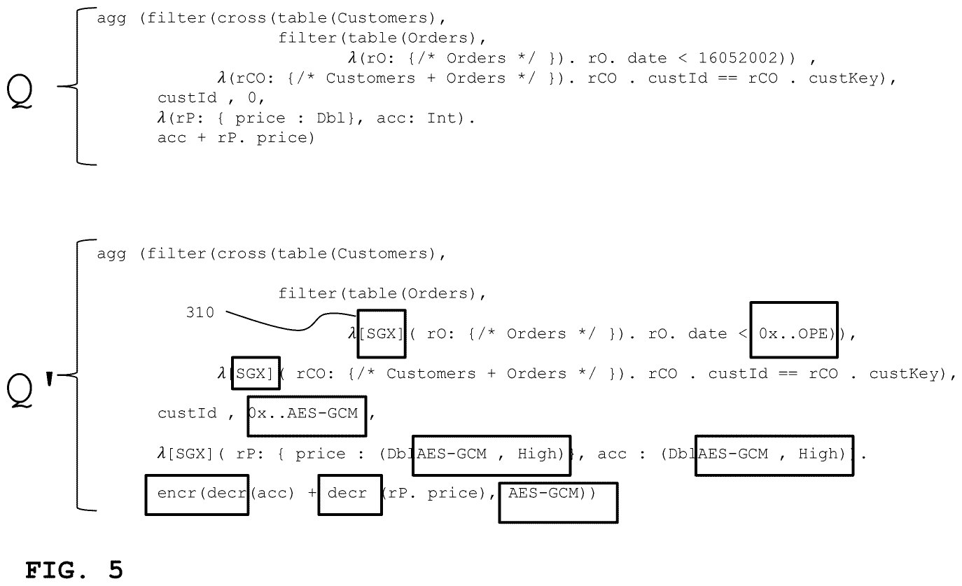

The skilled person is able to provide query statements with more details (cf. FIG. 4A with syntax examples, and FIG. 5 for a query with multiple operations). The response R comprises the result of the operation as well.

The trend to separate computers goes along with organizational separation: Simplified, organizations ALPHA and BETA that run client-side computers 110 may not be the organizations that run server-side computers 210. Multiple organizations ALPHA and BETA (and many more) at the edge may even be competitors, but they may use queries to the same data-center (to the same cloud computers).

From the view point of the organizations, they share resources (such as, for example, for storing) that the cloud offers, the so-called “shared cloud resources”. In FIG. 1, computers 110-1 and 110-2 (illustrated on the left side) should belong to organization ALPHA, and computers 110-3 and 110-4 (on the right side) should belong to organization BETA.

As it is mandatory that each organization (i.e., ALPHA, BETA) accesses its own data, shared access goes along with data isolation between the organizations.

### Transformer Module

FIG. 1 also illustrates—for ALPHA only—a transformer module 300 (or simply “transformer”) that modifies the original query Q (and that optionally modifies the response R). Module 300 could also be considered to be an annotator module.

The description differentiates the original query Q at the input of transformer module 300 from the annotated query Q′ at its output. With details to be explained, transformer module 300 allows data-analyst 190-ALPHA to define original query Q more easily than data-analyst 190-BETA (who does not benefit from a transformer). In other words, an original query Q from computers 110-1 or 110-2 (at organization ALPHA) would be less complex than a query (here: Q_BETA) from computers 110-3 or 110-4 (at organization BETA that does not go through a transformer).

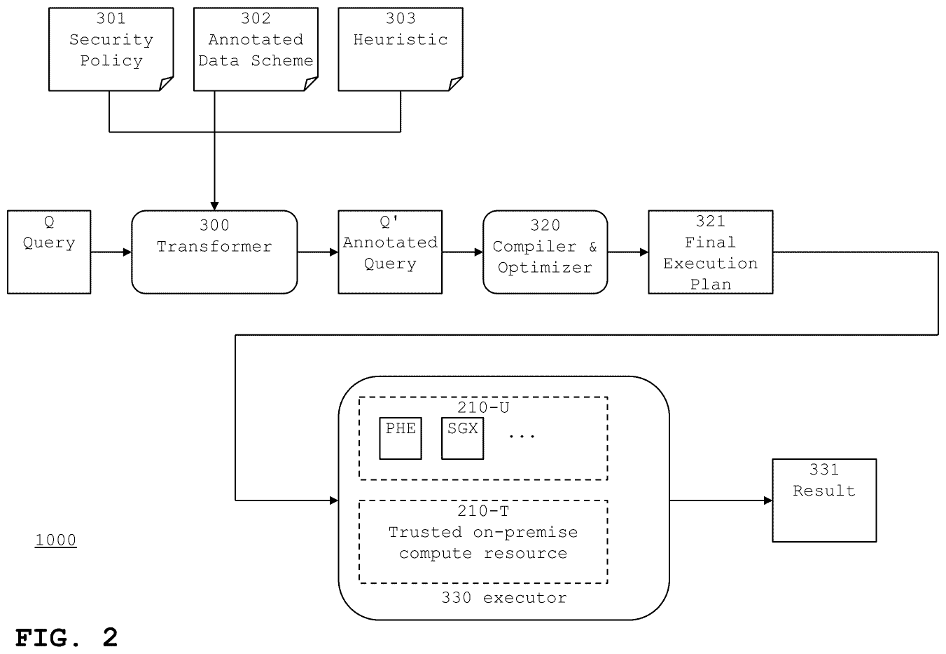

The use of transformer module 300 reduces complexity, in a particular way. The description discusses the complexity here and explains details for the solution in the following figures. Transformer module 300 parses the original query Q and provides annotations so that the original query Q turns into the annotated query Q′. The annotated query Q′ comprises meta-data to identify the encryption mechanism (meta-data or annotations, cf. 310-A, 310-B and 315 in FIG. 3). Transformer module 300 thereby uses the security policy (in the example that of organization ALPHA, cf. item 302 in FIG. 2).

In contrast, a query designed by data-analyst 190-BETA would have to comprise instructions for the encryption. Further, data-analyst 190-BETA would have to manually check for encryption compatibility between data to be combined.

In other words, original query Q is a logical query without security annotations, but transformer module 300 compensates the lack of encryption instructions by the annotations that it introduces automatically.

FIG. 2 illustrates system 1000 at least partially, but with optimal components (in rectangles with bended corners) and with intermediate results or the like (in rectangles with sharp corners) to illustrate a workflow. Intermediate results and intermediate instructions to obtain them can be runtime-only constructs that the data-center does not persist.

As already mentioned, original query Q is the input to transformer module 300 (cf. FIG. 1), and annotated query Q′ is the output from transformer module 300.

Transformer module 300 processes security policy 301, one or more annotated data schemes 302 and—optionally—processes heuristic 303.

### Compiler and Optimizer

The skilled person is familiar with compiling and optimizing queries, for example to reduce the access time by that data is retrieved from databases. For example, retrieving multiple items can be simplified if the items belong to the same column of a database table.

FIG. 2 therefore illustrates compiler-optimizer 320 that receives annotated query Q′. Having annotations in the query does not prevent to use compilation and optimization.

Compiler-optimizer 320 provides final execution plan 321 that is an instruction set for executor 330.

### Executor

The skilled person is also familiar with tools such as executor 330 to actually access the data (by processing the annotated query Q′, no matter if compiled/optimized or not). As illustrated, executor 330 can receive final execution plan 321, and can also return response 331 to the data-analyst (cf. R in FIG. 1). Response 331 may go back to client-computer 110 via transformer module 300 (cf. FIG. 1), or can by-pass it.

FIG. 1 has illustrated server-computers 210-1, 210-2, and 210-3, and FIG. 2 repeats them, but with some classification.

Depending on the original query Q, some data has to be retrieved from a first resource or from a second resource. The resources belong to data-center 200 (for example, a single data-center) or belong to multiple data-centers.

The annotations in query Q′ instruct compiler-optimizer 320 to prepare plan 321 such that different data and operation statements (e.g., for different data, for different operations) can be handed by different resources, or can be handled differently by the same resource.

By way of example, the first resource should be an untrusted cloud computer resource 210-U. However, resource 210-U does provide some security schemes, and the figure symbolizes them by well-known acronyms such as PHE, SGX, etc. In other words, security is provided by the security schemes that are installed on top of an untrusted resource.

By way of example as well, the second resource should be a trusted computing resource 210-T that is run by the same organization (e.g., ALPHA) that runs the client-computer (with the query). Compute resource 210-T can therefore be attributed to be “on-premise” and to be “trusted”.

### Complexity

The example with two resources in FIG. 2 already suggests complexity. Clouds (i.e., data-centers in terms of FIG. 1) can be distinguished into “private clouds” and “public clouds”. Simplified, a cloud can be “private” to a particular organization (if, for example, the cloud computers are run under control of the organization). A cloud can be a “public” cloud if its shared resources can be used by the edge computers of multiple organizations, as in FIG. 1. In the example, data-center 200 would offer a public cloud to both.

The terminology may vary, and the terms may be connotated with more or less measures for the above-mentioned data-security goals. Attributes such as “trust” or “non-trust” may convey an approximate indication regarding these data-security goals. For example, the cloud computers in a cloud that is private to a particular organization would offer trust to the edge computers (of that organization). As in FIG. 1, data-center 200 would be in a non-trust relation to the computers of both organizations ALPHA and BETA.

The skilled person is also familiar with the concept “on-premise” (cf. 210-T in FIG. 2), that is similar to “private cloud”. But the computers are physically located in proximity, and/or are protected by security measures (e.g., firewalls) that are run by a particular organization. Computers 110-1 and 110-2 would be “on-premise” of ALPHA, and computers 110-3 and 110-4 would be “on-premise” of BETA.

### Domain

It is convenient to apply the term “domain D”. As used herein, a domain summarizes the type of computer location in combination with pre-defined security settings.
For example, a trusted client-side domain (CLNT) may stand for the edge computers (such as 110-1, 110-2, 110-3, and 110-4) that perform data processing at the client-side such that security goals are complied with at least as long as the data stays at the client-side. For example, computers 110-1 and 110-2 could provide CLNT because they belong to a single organization ALPHA, and organization ALPHA would have taken security measures. By way of example, FIG. 1 illustrates computers 110-1 and 110-2 within firewall “alpha”. There is an assumption that the client-side of ALPHA would be protected. Computers 110-3 an 110-4 also would form CLNT (but for organization BETA).

In contrast, the computers in a public cloud domain CLD are located at the server-side and would provide basic security measures (such as for example encryption). But from the view-point of an organization, such basic measures would not be sufficient. CLD would therefore be “non-trusted”. For simplicity, it could be assumed that computers 210-1, 210-2 and 210-3 would form CLD, and that the organizations ALPHA and BETA would consider the basic measures no sufficient.
In a further example, a domain can be characterized by the availability of software guard extensions (SGX) as a security mechanism that can be used.

In other words, the skilled person can use word pairs (such as public/private, third-party-cloud/own-cloud, client/server, trust/non-trust, etc.) to characterize data-security (for particular tasks, storing, processing, querying, responding etc.). Provided that technical implementations details are specified, such and other terms can be used in the security policy (cf. 301 in FIG. 2).

Simplified, the skilled person would perform data-related activities in domains (D) that provide data-security. This is-however-not always possible. Further, performing security critical data processing in CLNT only would contradict the efficiency that data-center with cloud computers offer.

To meet security goals even if data is being stored (or processed) in domains that are non-trusted, the skilled person is familiar with taking a different approach. For example, data processing in a non-trusted environment (e.g., in the domain CLD) may be compliant with the security goals if appropriate measures are taken, such an encrypting data.

For simplicity of explanation, it can be assumed that query-and-response activities between computers 110-1 and 110-2 with computers 210 can be encrypted as defined by organization ALPHA, and that the activities with computers 110-3 and 110-4 for organization BETA are also encrypted, although with organization-specific settings (such as keys and the like).

For explanation only, original query Q should be a query to retrieve variables A and B (cf. FIG. 5, item 150, by statements “get A”, and “get B”, as well as the operation statement 155) from data-center 200, but the data would be encrypted.

### Schemes

The skilled person is familiar with different schemes(S) for encrypting (and for decrypting), and also knows that different schemes(S) have different technical requirements. The schemes(S) perform data-related activities with different efficiency (i.e., with different performance characteristics), different application modalities, etc.

Encrypting according to a first scheme (S1) may require more computational efforts than encrypting according to a second scheme (S2). If the first scheme (S1) would provide a relatively higher protection against attacks, such relatively higher efforts may be justified. Further, performance characteristics for operations with actual data can strongly vary.

Similar constrains apply for decrypting as well. Handling keys or the like may by different between schemes as well. Some schemes may be associated with implementations in hardware (e.g., trusted security chip), others may rely on software only.

Schemes can be associated with the personal names of their developers and/or with names in acronyms. The skilled person is familiar, with schemes such as AES-GCM (advanced encryption standard Galois counter mode), SWP, AES-ECB (advanced encryption standard electronic codebook), Paillier, ElGamal, OPE (order-preserving encryption). The skilled person would simply write ZERO for “no encryption”.

Further, schemes can be differentiated further. While a particular scheme uses a pre-defined and standardized sequence of computation steps, schemes may use different conventions. For example, AES-GCM can perform calculations with different data formats. AES-GCM with data in the “Str” format is different from AES-GCM with data in the “Dbl” format (double).

As the technical requirements are applicable for intruders or adversaries as well, different schemes(S) are vulnerable to attacks differently.

Information owners can associate data types and security measures in so-called policies. Policies may use a further intermediate level of abstraction. Such abstraction can be, for example, based on confidentiality levels. And the levels (L) can be identified by labels. For example, a policy may set a first label for a high confidentiality level (e.g., L=HIGH for medical data) and may set a second label for a lower level (e.g., L=LOW for other data).

In other words, sensitive data (such as medical data for particular patients) would have to be processed by the scheme S that would be most difficult to break, but public data (such as the traffic speed limits of particular streets) would not have to be encrypted at all.

It is noted that organizations ALPHA and BETA would usually apply different policies.

Relatively simple policies may demand, for example,
(domain only policies) to process data with L=HIGH in particular domains (D) only, such as in CLNT, or in an alternative example to process L=HIGH data in a domain that supports SGX (cf. 210-U in FIG. 2).
(scheme only policies) to process data with L=HIGH with particular schemes(S) only, such as AES-GCM, and to allow data at L=LOW to stay non-encrypted.

Schemes can be further differentiated into schemes that allow homomorphic encryption (e.g., Pallier, or ElGamal) and schemes that do not provide or exhibit any homomorphism.

Both the domain (D) approach and the scheme(S) approach are independent from each other (i.e. orthogonal).

Such simplicity in the policies would contract efficiency, and more sophisticated policies would try to combine D and S (mixed policies). But complexity further rises if domains (D) and schemes(S) are considered.

For example, data in a first domain (D1) would have to be encrypted (and decrypted) by one or more particular schemes (S1, S2, etc.), and data in a second domain (D2) would have to be encrypted otherwise. In the example of FIG. 1, computers 210 would be in D1 (that is from the view point of ALPHA).

Policies may differentiate security requirements at still finer granularity. To take an example for business data in a database (at computer 210) with different fields (or columns), a customer ID is usually a database field with a relatively low requirement (L=LOW) for encryption, but the data regarding financial spending or the like would be a DB field with the requirement HIGH. Labeling both fields with HIGH would be possible, but the query would take more computation time (because the customer ID would eventually have to be decrypted as well).

Policies and security schemes may be different for different storage locations (i.e., in the cloud, even for the same domain), and security setting may vary even within the same location.

These introductory examples give some hints to the overall complexity. In one of many use-case scenarios, edge computer 110-1 should run a data analytics application. The application issues one or more queries, but the query accesses data that complies with one or more policies and that is available in encrypted form according to different schemes S). Even worse, the query may access data from distributed sources, and potentially from distributed storage locations within the cloud. Labels (such as LOW or HIGH) may be applicable for all elements to be accessed, but technically, data with the label HIGH may be encrypted under different schemes.

From the view point of data-analyst 190-ALPHA (who should be responsible for computer 110-1), a simple question into data-center 200 (e.g., to ask for the overall spending for all customers) would require a more complicated query with the encryption details (not necessarily the key itself). Data-analysts are not necessarily programmers. Data-analyst 190-BETA who is working for BETA faces the same challenges.

Traditionally, information flow control between edge and cloud computers would be organized by security mechanisms (or security concepts) such as domains (D) and schemes(S) separately.

In principle, both concepts are orthogonal to each other, so there is no influence between D and S. However, they could be combined, and the disclosed approach allows such a combination.

### Lattice Concept

Simplified, the domain D and scheme S definitions in a policy (e.g. the policy for ALPHA) are related by levels L that are mapped to confidentiality requirements of the data. For example, the levels can be ZERO, LOW and HIGH. The levels are directed (e.g., LOW is higher than ZERO, HIGH is higher than LOW) and limited (e.g., ZERO is lowest, HIGH is highest). An encryption mechanism for a particular data set that at level LOW must be encrypted by a domain and scheme combination that provides LOW, or that provides HIGH, but must not encrypted by a domain and scheme combination at ZERO.

The level order in the lattice can be written in arrow notation, for example as HIGH-->LOW-->ZERO. The direction of the arrow is just a convention. Higher-ranking levels could be used for data to be encrypted at lower-ranking levels, but not vice versa. Other labels could be used as well: {HIGH, LOW, PUBLIC} or {HIGHEST, HIGH, MEDIUM, LOW, ZERO}, etc.

Confidentiality constraints are based on a finite set {L} of security labels (also levels or security classes.

The lattice concept allows to extract confidentiality constraints, from the original query Q, and allows to identify the encryption (decryption) that is required for particular data types.

### Security Mechanisms

By way of example, the description reviews some software-based schemes.

Homomorphic encryption (HE) allows data to be computed with while it is encrypted (i.e., computations on encrypted data). Fully homomorphic encryption (FHE) cryptosystems support arbitrary computations over encrypted data but exhibit substantial overheads.

Partially homomorphic encryption (PHE) cryptosystems are generally much more efficient, however, but each cryptosystem can only support certain operations-such as, for example, addition of ciphertexts (Paillier being additively homomorphic) or multiplication of ciphertexts (ElGamal multiplicatively homomorphic)

The limitations can be overcome, e.g., by using few trusted resources on the client side to complete queries by performing remaining operations on data in plaintext or re-encrypting data. But determining when and how to do so most efficiently in a given data query adds to the difficulty of choosing between different cryptosystems, understanding their security properties, and employing them correctly in combination.

The selection of the appropriate scheme is related to efficiency. If processing (for example by computer 110 with a query for A+B) would be an addition operation (e.g., variable C=variable A plus variable B), using PHE might be an option, because decrypting might not be required.

In theory, using other schemes such as above-mentioned FHE would be possible, but the overhead contradict efficiency. The lattice concept makes it possible to select the most appropriate scheme, without loosing confidentiality.

By way of example, the description now reviews some hardware-based schemes. Several hardware-based mechanisms have also been proposed, including the above-mentioned software guard extensions (SGX) that are commercially available by Intel Corporation (Santa Clara, CA, US), secure encrypted virtualization (SEV) that are commercially available by Advanced Micro Devices, Inc. (AMD, Santa Clara, CA, US), etc.

Different cloud services (e.g., data-center 200 is only one particular service) may use different mechanisms (e.g., one using SGX, another using SEV and so on). Further, the mechanisms have specific security and performance properties, and are non-trivial to set up (e.g., using remote attestation via trust authority) and use by programmers (e.g., identify sensitive data, reason about information flow, partition programs to minimize trusted computing base).

The lattice approach can be advantageous as well: The transformer module can know what the cloud computers provide (e.g., computing on encrypted data) and can make the annotations accordingly. Hardware-based and software-based mechanisms can be used alone or in combination. Simplified, if a data statement is related (in the lattice) to a particular level (such as, for example, HIGH), the transformer module can look up for the security mechanism that is available by data-center 200. This could be a mechanism to be applied in particular domains (D), with particular schemes(S) and so on. Data-analyst 190-ALPHA does not have to specify that, his or her colleague-data-analyst 190-BETA-would have to do so. In other words, and more in general, a security policy can be extended to provide a mapping, such as from the particular level to the appropriate mechanism.

### Lattice Concept Expanded to Operations

As already mentioned, the original query Q′ comprises one or more operation statements. Having such statements in a query Q increases complexity because the type of operation (cf. FIG. 4A for examples, such as Prim ops, query ops) is related to the data statements. As mentioned already, PHE can be a mechanism to apply for certain operations (e.g., multiplication) and can offer efficiency benefits, but PHE would have to be applied with the correct pre-defined settings.

A security policy that is based on the lattice concept can easily be used to identify an appropriate operation mechanism. Security mechanisms and operation mechanisms are related. For PHE, certain operations can be performed without decryption. If, for example, the security policy demands PHE for the data statements, the transformer module can derive the applicability of PHE for the processing and can identify the mechanism to access the data to be processed. In other words, the lattice concept for the security mechanisms can optionally be expanded to let the transformer module identify the operation mechanism as well.

### Scheme Identification

As used herein, the description will refer to schemes S that are identified as follows: High CLD, AES-GCM, SWP, AES-ECB, Paillier, ElGamal, OPE. For simplicity of explanation, it is sufficient to use the acronyms.

### Query Example

FIG. 3 illustrates a part of the system of FIG. 1: client-computer 110-1 and transformer module 300. Client-computer 110-1 should be operated by data-analyst 190-ALPHA. By way of example, original query Q should be a query to retrieve variables A and B and to perform an operation f(A, B) or “A(+) B”. In the database example, variables A and B can be “orderId”, “price” and the like.

Original query Q comprises first data statement 150-A and second data statement 150-B. The figure is simplified so that in other implementations, there could be more statements.

Transformer module 300 provides annotations 310-A and 310-B (to first and second data statements 150-A and 150-B respectively).

The annotations are illustrated here as rectangles. FIG. 4B repeats the writing convention by showing annotation examples in rectangles as well.

### Processing Mechanism as Part of the Query

FIG. 3 also symbolizes that original query Q indicates operator 155 (i.e. the operation statement), here symbolized by the “circled plus” symbol (+). Operator 155 specifies an operation to be applied to the data. In the database example, the query may seek to identify particular customers and to calculate the sums of their purchases.

Response 331 (cf. FIG. 2) would be the result of the operation. For example, the operator (+) could be the instruction that both variables A and B would have to be multiplied (i.e., * symbol), and the result would be C=A*B.

In view of security (and in particular of confidentiality) it can be relevant where the decryption is performed.

In a first case, the variables would have to be decrypted before applying the operation (i.e., decrypt A and decrypt B and calculate A*B). According to the policy, decrypting may be restricted. For example, if executor 330 would be associated with untrusted cloud compute resource 210-U, decryption would have to be performed in SGX (i.e. in an enclave to resource 210-U). The result (i.e., C) would have to be forwarded in response 331.

In a second case, the variables could stay encrypted while applying the operation. This is possible for some combinations of encrypting mechanism and processing mechanisms. For example, for PHE the variables A and B can stay encrypted provided that they have been encrypted by a PHE-compatible scheme (such as ElGamal). There is no need to use SGX. The result would be (in still encrypted form) available in response 331.

The security policy can also indicate the processing mechanism that would have to be applied. For example, transformer module 300 would annotate variables A and B to be encrypted with a particular PHE-compatible mechanism, and would also annotate (as part of instruction 315 to executor 330) that a particular PHE scheme has to be applied. The identification of the particular mechanism can be done by heuristic 303.

There is some synergy available: the security policy comprises rules how to select operations, and the annotations (that would have to indicate the security mechanism for the data) can also indicate the security mechanism for the operation.

FIGS. 4A and 4B illustrate aspects of the programming languages. FIG. 4A illustrates the syntax for original query Q (that is not yet annotated), and FIG. 4B illustrates the syntax for annotated query Q′.

The programming language for original query Q can be considered as a sub-set for the programming language for annotated query Q′. Or, the original query Q is written in a first programming language, and the annotations are written in a second programming language, with the second language being an extension to the first language.

Figures (such as FIG. 2) and description symbolize the original query Q with a first statement “get A” and with a second statement “get B”. The data-analyst may specify the original query Q with a programming language (such as in FIG. 4A), and can for example, differentiate data by types and prime types, to identify expressions (for calculations), to identify operations that belong to the query.

For example, the data-analyst may add some details to the data: for example, the following, in FIG. 4A:
a data type k
the identification of a primitive type for that type (e.g., integer Int, string Str, etc.)
a value v, or a value range
an expression (that can also be the specification of a table name)
a mathematical operation (the figure just gives some examples, for a primary operator (+) that could be “+” or “−”, etc.)
an operation ϑ that should be applied as well (e.g. to filter or to aggregate data)

FIG. 4B further illustrates elements that are in the annotations. The syntax of FIG. 4B is not required to be applied by the data-analyst.

FIG. 4B uses two symbols: Rectangles illustrate language elements for query annotations (cf. FIG. 3 for annotations 310-A and 310-B), and rectangles with bended corners illustrate intermediate expressions (in use by the transformer module). Intermediate expressions (cf. the above-mentioned run-time constructs) are—however—not required.

As already mentioned, the annotations are based on schemes (S) and domains (D). The figure uses lowercase letters just to indicate that they can be selected from sets (here in ::=notation).

For example, schemes (S) can be “zero”, AES-GCM, ElGamal, Paillier and so on. Of course, the annotations do not have to write “AES-GCM” verbatim, they can use any other coding.

For example, the domains (D) can be identified by the acronyms that have been explained already, or otherwise.

FIG. 4B is simplified in showing a single rectangle drawing around all possible annotations.

Particular domains (D) and particular schemes (S) can be annotated to elements. For example in FIG. 4B, in the row “value”, the figure shows that the indication of a particular scheme (S) can be by a superscript to a variable. This is merely an example, the schemes could be annotated by subscript, superscript or otherwise (e.g., FIG. 5 does not use subscript or superscript).

For example, a domain can be annotated within []. Using different conventions to annotate domains and schemes is convenient: the components that receive original Q (cf. compiler-optimizer 320 in FIG. 2) can differentiate domains from schemes more easily (i.e., with less complexity).

Expressions can be written by differentiating “encryption” from “decryption” with the argument in parenthesis. For example, “encr (e, s)” indicates that an expression “e” is encrypted by a particular scheme s. For example, for the expression “Get A” in the query Q the transformer module analyzes the query according to the policy and annotate that data statement to “Get (encr (A, ElGamal)”. While the data-analyst uses the programming language to retrieve a variable A, the transformer module annotates that the variable A is available as a cipher based on the encryption scheme S=ElGamal. For retrieving the data (i.e., by executing the query Q) the indication of the scheme is important, but the data-analyst does not have to indicate that.

In view of FIG. 1, data-analyst 190-ALPHA can simply write “Get A”, but data-analyst 190-BETA has to write a query with all details (not necessarily in the language of the annotations). In other words, the transformer module uses one of the schemes in an annotation.

### Database Example

For the relation “customers”, database fields could be “custId” and “bal” (with the semantic to identify a particular customer and to identify an associated monetary amount).

For the relation “orders”, database fields could be “orderId”, “custKey”, “price”, and “date” (with self-explaining semantics).

The database can use different data formats, and by way of example, field could have the following formats: Str (string, for “custID”, for “orderId”, for “custKey”, and for “price”), Dbl (double, for “bal”), Int (integer, for “date”).

Security labels can be set, for example, with HIGH for “bal”, for “orderId” and for “price”, and with LOW for other data.
For example, the following security policy can be defined by the following: For label HIGH in the CLNT domain or in a domain in that SGX is available, no further mechanisms are required (i.e., ZERO)
For label HIGH in the CLD domain, the scheme AES-GCM would be required.
For label LOW, in the CLD domain, the schemes can be any of SWP, AES-ECB, Paillier, ElGamal, and OPE.

Data-analyst 190-BETA would have to take care about that policy, but for data-analyst 190-ALPHA, transformer module 300 steps in here.

The description now explains how this can be automated.

### Original and Annotated Query Example

FIG. 5 illustrates original query Q on top of the page and illustrates annotated query Q′ below. By way of example, original query Q is directed to a database that has tables with data for customers and with data for orders. The comments/* . . . */merely indicate that some well-known details (such as the identification of the tables) are omitted for simplicity. In practical implementations such a query would be longer (to identify tables etc.)

Original query Q comprises data statements that identify data to be accessed, such as customer identification data, data regarding orders, and other data.

Original query Q further comprises operation statements that identify the way by that data should be processed, for example, by establishing relations between order data and customer data, by filtering and by aggregating (cf. FIG. 4A the primitive operations “prim ops”, the query operations “query ops”). For example in FIG. 5, the result “rP” should be calculated by summing up the values for variables “acc” and “rP.price”.

Query Q is written in a programming language for the above-mentioned analytics engine SPARK. For example, the language uses the lambda notation (λ, with dots) to assign semantics to variables. For example, the intermediate variable “r0” is related to a particular calendar data, the intermediate variable “rP” is related to prices (with some definition regarding the format “Dbl”), the intermediate variable “acc” stands for an intermediate sum, and so on.

Query Q also identifies a particular calendar date (“16052002”).

Such an original query Q does not comprise security annotations, and it can be assumed that it would be created by data-analyst 190-ALPHA.

In annotated query Q′, the transformer module has added annotations 310. The figure indicates them by rectangles. For example, data relating to pricing (in the format “Dbl”) is annotated by a particular encryption scheme (here: AES-GCM, written in superscript), because in the example, the security policy labels that data as “HIGH”.

The annotation also indicates that the variable “acc” with (optional) label HIGH is encrypted in AES-GCM as well and that the format changes from “Int” (integer) to Dbl.

Regarding the particular calendar date, there is no secret that it was a Thursday, but since the security policy takes the selection of a calendar data as a LOW labelled data item, the transformer module already encrypts that and indicates the mechanism: OPE.

The processing (such as to sum up the variables “acc” and “rP-price”) is annotated as well: with decrypting “acc” and “rP.price” separately, summing them up and encrypting with AES-GCM.

The annotation also indicates (here given right to the lambda) that the encryption and decryption calculations are to be performed in SGX (cf. FIG. 2).

### Method

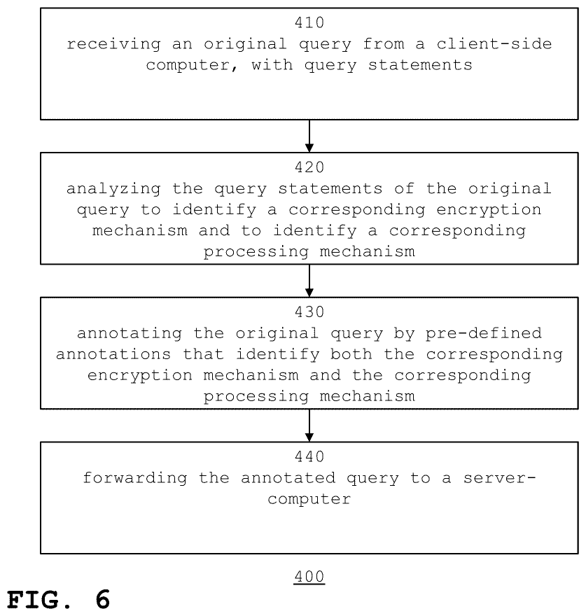

FIG. 6 illustrates a flow-chart of computer-implemented method 400 for processing data that are stored in a data-center with server-computers.

The transformer module (reference 300 in FIGS. 1-3) is receiving (step 410) an original query (cf. Q in FIG. 1) from a client-side computer. As explained above, the original query comprises query statements that are (i) at least first and second data statements (150-A, 150-B in FIG. 3) that identify the data to be accessed, and (ii) at least one operation statement (155 in FIG. 3) that identifies an operation to be performed with the data.

The transformer module is analyzing (step 420) the query statements of the original query to identify a corresponding encryption mechanism and to identify a corresponding processing mechanism. Transformer module 300 operates according to a pre-defined security policy.

The transformer module is annotating (step 430) the original query by pre-defined annotations (cf. FIGS. 4B, 5) that identify both the corresponding encryption mechanism and the corresponding processing mechanism.

The transformer module is forwarding (step 440) the annotated query (cf. Q′ in FIGS. 1-3) to a server-computer (e.g., 200 in FIG. 1).

Optionally, an executor module that is associated with the server-computer, is receiving and processing the annotated query. According to the annotations, the executor module processes the statements at different storage locations in the data-center and activates the corresponding encryption schemes.

Optionally, the corresponding encryption mechanism and the corresponding processing mechanism use partially homomorphic encryption so that the executor module accesses and processes the data in encrypted form.

Optionally, the statements are defined by symbols in a first programming language. The transformer module provides the annotations in a second programming language that is an extension to the first programming language (cf. FIG. 4A for the first language and FIG. 4B for the second language).

Optionally, step annotating 430 the original query Q comprises to annotate the query with runtime-only constructs that the data-center does not persist (cf. run-time terms in FIG. 4B).

Optionally, the step analyzing 420 the first and second data statements is based on a policy that uses a lattice structure with a finite and pre-defined number of ordered confidentiality levels so that the transformer module identifies encryption mechanisms that are level-compatible.

Optionally, the corresponding encryption mechanisms are specific to encryptions schemes and to domains.

Optionally, in step analyzing 420, the transformer module identifies the corresponding processing mechanism also according to the policy with the lattice structure.

Optionally, the step annotating 430 the received original query Q is followed by compiling the annotated query Q′ by a compiler-optimizer module (cf. 320 in FIG. 2) so that forwarding is performed with a compiled query.

Optionally, the step analyzing 420 the first and second data statements and the operation statement of the received original query comprises to identify an encryption scheme by that the data from the first and second data statements is being processed by homomorphic encryption.

### Further Discussion

The description has presented a method to process data with the focus to preserve confidentiality of information. However, the same method is applicable for other security goals as well. For example, the above-mentioned goal to keep the integrity of information can be accomplished likewise. In other words, the annotations can point to security mechanics to support data confidentiality, to support data integrity and so on.

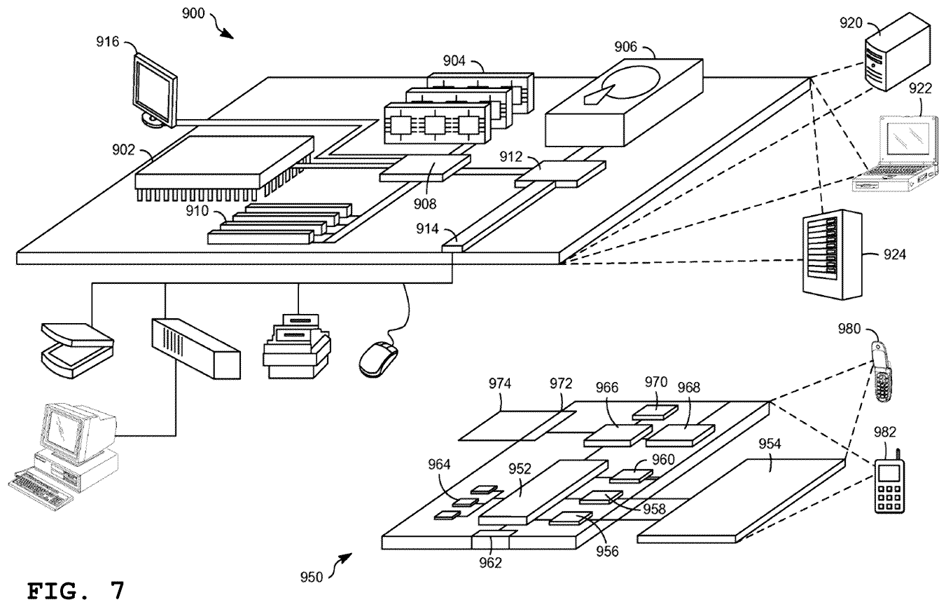

FIG. 7 illustrates a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Generic computer device may 900 correspond to a computer in the computer system of FIG. 1. Computing device 950 is intended to represent various forms of mobile devices, such as personal digital assistants, cellular telephones, smart phones, and other similar computing devices. For example, computing device 950 may include the data storage components and/or processing components as shown in FIG. 1 and in other figures. The components shown here, their connections and relationships, and their functions, are meant to be exemplary only, and are not meant to limit implementations described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 964, expansion memory 984, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation-and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the description.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. Computer-implemented method for processing data being stored on server-computers in a data-center, the method comprising:
by a transformer module, receiving an original query from a client-side computer, wherein the original query comprises query statements that are:
(i) first and second data statements that identify the data to be accessed, and
(ii) an operation statement that identifies an operation to be performed with the data;
by the transformer module and according to a pre-defined security policy, analyzing the first and second data statements of the original query to identify a corresponding encryption mechanism for the data to be accessed, and analyzing the operation statement to identify a corresponding processing mechanism;
by the transformer module, annotating the original query by pre-defined annotations that identify both the corresponding encryption mechanism and the corresponding processing mechanism, to obtain an annotated query; and
by the transformer module, forwarding the annotated query to a server-computer in the data-center.

2. Method according to claim 1, further comprising:
by an executor module that is associated with the server-computer, receiving and processing the annotated query, wherein according to the annotations, the executor module processes the statements at different storage locations in the data-center and activates the corresponding encryption mechanism.

3. Method according to claim 2, wherein the corresponding encryption mechanism and the corresponding processing mechanism use partially homomorphic encryption so that the executor module accesses and processes the data in encrypted form.

4. Method according to claim 1, wherein the statements are defined by symbols in a first programming language, and wherein the transformer module provides the annotations in a second programming language that is an extension to the first programming language.

5. Method according to claim 1, wherein the step annotating the original query comprises to annotate the original query with runtime-only constructs that the data-center does not persist.

6. Method according to claim 1, wherein the step analyzing the first and second data statements is based on a policy that uses a lattice structure with a finite and pre-defined number of ordered confidentiality levels so that the transformer module identifies encryption mechanisms that are level-compatible.

7. Method according to claim 6, wherein the corresponding encryption mechanismis specific to encryption schemes and to domains.

8. Method according to claim 7, wherein in step analyzing, the transformer module identifies the corresponding processing mechanism also according to the policy with the lattice structure.

9. Method according to claim 1, wherein the step annotating the original query is followed by compiling the annotated query by a compiler-optimizer module so that forwarding is performed with a compiled query.

10. Method according to claim 1, wherein the step analyzing the first and second data statements and the operation statement of the received original query comprises to identify an encryption scheme by that the data from the first and second data statements is being processed by homomorphic encryption.

11. A computer program product for processing data being stored on server-computers in a data-center, the computer program product being tangibly embodied on a non-transitory computer-readable storage medium and comprising instructions that, when executed by at least one computing device, are configured to cause the at least one computing device to:
by a transformer module, receive an original query from a client-side computer, wherein the original query comprises query statements that are:
(i) first and second data statements that identify the data to be accessed, and
(ii) an operation statement that identifies an operation to be performed with the data;
by the transformer module and according to a pre-defined security policy, analyze the first and second data statements of the original query to identify a corresponding encryption mechanism for the data to be accessed, and analyzing the operation statement to identify a corresponding processing mechanism;
by the transformer module, annotate the original query by pre-defined annotations that identify both the corresponding encryption mechanism and the corresponding processing mechanism to obtain an annotated query; and
by the transformer module, forward the annotated query to a server-computer in the data-center.

12. The computer program product of claim 11, wherein the instructions, when executed, are further configured to cause the at least one computing device to run an executor module that is associated with the server-computer, to receive and to process the annotated query, wherein according to the annotations, the executor module processes the statements at different storage locations in the data-center and activates the corresponding encryption mechanism.

13. The computer program product of claim 12, wherein the instructions, when executed, are further configured to cause the at least one computing device for the corresponding encryption mechanism and the corresponding processing mechanism to use partially homomorphic encryption so that the executor module accesses and processes the data in encrypted form.

14. The computer program product of claim 11, wherein the instructions, when executed, are further configured to cause the at least one computing device access statements that are defined by symbols in a first programming language, and to let the transformer module provide the annotations in a second programming language that is an extension to the first programming language.

15. A system for processing data being stored on server-computers in a data-center, the system comprising: at least one memory including instructions; and at least one processor that is operably coupled to the at least one memory and that is arranged and configured to execute instructions that, when executed, cause the at least one processor to:
by a transformer module, receive an original query from a client-side computer, wherein the original query comprises query statements that are:
(i) first and second data statements that identify the data to be accessed, and
(ii) an operation statement that identifies an operation to be performed with the data;
by the transformer module and according to a pre-defined security policy, analyze the first and second data statements of the original query to identify a corresponding encryption mechanism for the data to be accessed, and analyze the operation statement to identify a corresponding processing mechanism;
by the transformer module, annotate the original query by pre-defined annotations that identify both the corresponding encryption mechanism and the corresponding processing mechanism to obtain an annotated query; and
by the transformer module, forward the annotated query to a server-computer in the data-center.

16. The system of claim 15, wherein the instructions, when executed, are further configured to cause the at least one processor to run an executor module that is associated with the server-computer, to receive and to process the annotated query, wherein according to the annotations, the executor module processes the statements at different storage locations in the data-center and activates the corresponding encryption mechanism.

17. The system of claim 16, wherein the instructions, when executed, are further configured to cause the at least one processor to let the corresponding encryption mechanism and the corresponding processing mechanism use partially homomorphic encryption so that the executor module accesses and processes the data in encrypted form.

18. The system of claim 15, wherein the instructions, when executed, are further configured to cause the at least one processor to use he statements that are defined by symbols in a first programming language, and wherein the transformer module provides the annotations in a second programming language that is an extension to the first programming language.

19. The system of claim 15, wherein the instructions, when executed, are further configured to cause the at least one processor-in the step analyzing-to let the transformer module identify the corresponding processing mechanism also according to the policy with a lattice structure.

20. The system of claim 15, wherein the instructions, when executed, are further configured to cause the at least one processor-after having performed the step annotating the received original query-to compile the annotated query by a compiler-optimizer module so that forwarding is performed with a compiled query.
